(19) United States
(12) Patent Application Publication
(10) Pub. No.: US 2024/0304167 A1
(43) Pub. Date: Sep. 12, 2024

(54) GENERATIVE MUSIC SYSTEM USING RULE-BASED ALGORITHMS AND AI MODELS

(71) Applicant: BELLEVUE INVESTMENTS GmbH & Co. KGaA, BERLIN (DE)

(72) Inventors: DIETER REIN, BERLIN (DE); JURGEN JARON, BERLIN (DE)

(73) Assignee: BELLEVUE INVESTMENTS GmbH & Co. KGaA, BERLIN (DE)

(21) Appl. No.: 18/597,510

(22) Filed: Mar. 6, 2024

Related U.S. Application Data
(60) Provisional application No. 63/450,136, filed on Mar. 6, 2023.

(51) Int. Cl. G10H 1/00

(52) U.S. Cl. CPC G10H 1/0025

(57) ABSTRACT

According to a first embodiment, there is presented here a method of rule-based algorithmic generative music system. Templates are provided that contain all the information needed to build a music work, wherein this information combines the vast audio material stored in databases efficiently for selection, arrangement, and adaptation and in the end generation of the output music work.

### CROSS REFERENCE TO RELATED APPLICATIONS

This application claims the benefit of U.S. Provisional Patent Application Ser. No. 63/450,136 filed on Mar. 6, 2023, and incorporates said provisional application by reference into this document as if fully set out at this point.

### TECHNICAL FIELD

The instant invention relates generally to methods of generating music works and, more particularly, methods of automatically generating music works via a rule-based approach that utilizes structured and customizable algorithmic templates and AI technology.

### BACKGROUND

Creation of a musical work has been a goal and dream of many people for as long as music has been around. However, a lack of knowledge of details regarding the intricacies of music styles has prevented many from generating and writing music. As such, this endeavor has, for a very long time, been a privilege of people having the necessary knowledge and education.

With the advent of personal computers and the widespread development of specialized software for these devices in the home consumer market software, products have emerged that allow a user to create pleasing and useful musical compositions without having to know music theory or needing to understand music constructs such as measures, bars, harmonies, time signatures, key signatures, music notation, etc. These software products generally provide graphical user interfaces that feature a visual approach to song and music content creation that allows even novice users to focus on the creative process by providing easy access to the process of music generation.

Additionally, these software products have simplified for the user access to content useful for the generation of music. A multitude of individual sound clips, e.g., sound loops or just “loops”, are usually provided to the user for selection and insertion into the tracks of a graphical user interfaces. With these sorts of software products, the task of music or song generation has come within reach for an expanded audience of users, who happily take advantage of the more simplified approach to music or song generation. These software products have evolved over the years, gotten more sophisticated and more specialized, and some have even been implemented on mobile devices.

However, the general approach to music or song generation according to this approach has remained virtually unchanged. i.e., the user is required to select individual pre-generated loops that represent different instruments, for example drums, bass, guitar, synthesizer, vocals, etc., and place them in digital tracks to generate individual song parts that have lengths of 4 or 8 measures. Using this approach most users are able to generate one or two of these song parts with the help of the graphical user interface of a mobile or desktop-based software product. However, this tends to produce an unfinished music work, because the generation of a complete, musically pleasing music work is a task that is not practicable for most users, who will then leave the music work unfinished and abandon the attempt to generate music works.

Heretofore, as is well known in the media editing industry, it should now be recognized, as was recognized by the present inventors, that there exists, and has existed for some time, a very real need for a system and method that would address and solve the above-described problems.

Thus, what is needed is a system and method for a rule-based algorithmic generative music system that is easily accessible to the user and that provides an algorithmic approach utilizing structured and customizable templates that integrate AI technology and utilize provided, pre-prepared databases containing data content for use by the instant invention.

Before proceeding to a description of the present invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

According to a first embodiment, there is presented herein a generative music system using rule-based algorithms organized in selectable templates for music generation utilizing AI technology. The generative music system utilizes a three-phase process for generating a musical work—the three phases are an input phase, a data determination phase and, last, a render phase. The input phase collects, compacts and organizes data provided by the user and the inventor. In the data determination phase of the instant invention the data collected in the input phase is put through a multi-step process wherein data values are determined that represent music work generation values that are then finally utilized in the render phase.

The foregoing has outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1 is a diagram showing the general environment of the invention.

FIG. 2 illustrates the layout and data content of the audio collection of an embodiment.

FIG. 3 illustrates an automix algorithm utilized by the instant invention.

FIG. 4 is a diagram showing the structure of a template algorithm usable by the instant invention.

FIG. 5 discloses a preferred layout of the music work as arranged by an embodiment.

FIG. 6 illustrates an example of a workflow suitable for use with the instant invention.

FIG. 7 discloses a preferred workflow that could be used when generating the data values for the building of multiple seed parts.

FIG. 8 discloses one possible workflow that might be used when generating seed parts according to the instant invention.

FIG. 9 illustrates one approach to integrating AI functionality into the music work generation process.

The invention will be described in connection with its preferred embodiments. However, to the extent that the following detailed description is specific to a particular embodiment or a particular use of the invention, this is intended to be illustrative only and is not construed as limiting the invention's scope. On the contrary, it is intended to cover all alternatives, modifications, and equivalents included within the invention's spirit and scope, as defined by the appended claims.

### DETAILED DESCRIPTION

While this invention is susceptible of embodiment in many different forms, there is shown in the drawings, and will be described hereinafter in detail, some specific embodiments of the instant invention. It should be understood, however, that the present disclosure is to be considered an exemplification of the principles of the invention and is not intended to limit the invention to the specific embodiments or algorithms so described.

As is generally indicated in FIG. 1 at least a portion of the instant invention will be implemented in form of software 105 running in a client-server architecture on both a server computer 100 and a plurality of individual client devices, such as, for example only, smart phones 120, tablet devices 130 and a computer 110 that remotely access the server computer. The computer 100, might include a desktop computer, laptop computer, etc. Additionally, programmable devices such as smart phones 120, tablet devices 130, etc., running their own software might be used in conjunction with various embodiments and could provide input to the server computer 100 or receive processed music, video, etc., and display same to a user. In some embodiments, various aspects of an embodiment might be executed on such devices. All such devices will have some amount of internal program memory and storage (including magnetic disk, optical disk, SSD, etc.), which might be either internal or accessible via a network as is conventionally utilized by such units. As is generally indicated, a smart phone 120, tablet devices 130 might communicate wirelessly with the server computer 100 via, for example, Wi-Fi or Bluetooth. For purposes of generality in the text and claims that follows, when the terms “computer”, “computer device”, “computing device”, “CPU”, etc., are used those terms should be broadly interpreted to include any programmable device capable of executing some aspect of the various embodiments of the invention disclosed herein.

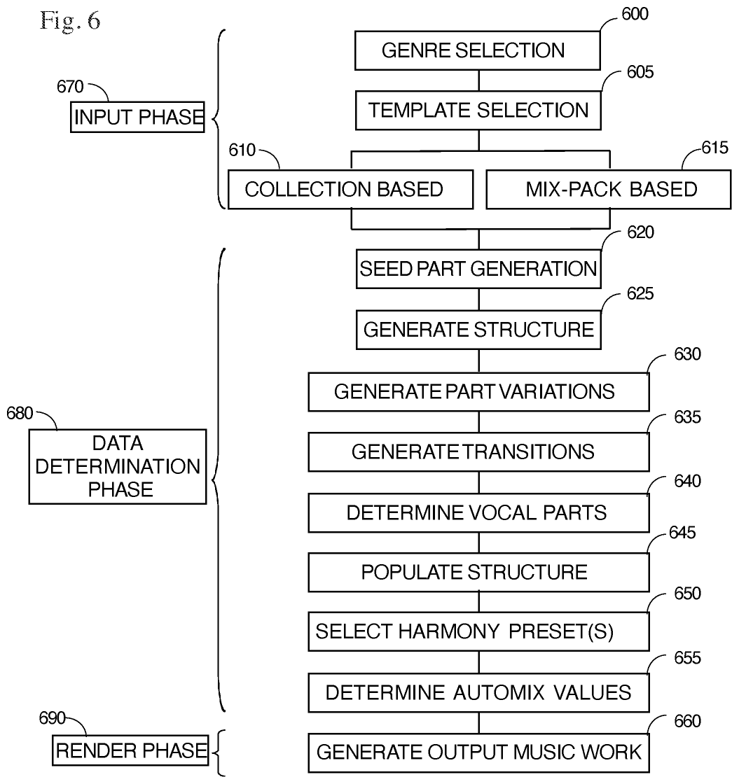

By way of a general introduction, FIG. 6 contains a high-level representation of an operating logic suitable for use with an embodiment. As is illustrated, the workflow might be broadly separated into three different phases, phases that represent the music work generation approach of the generative music system according to this instant invention. The first general phase is the input phase 670, wherein the data necessary for the generation of the music work is determined and selected, preferably by the user. The second phase might be defined as a data determination phase 680, wherein data values are defined, sorted, and provided as an output for implementation during the render phase 690 which is the third and final phase of the workflow of the instant invention. Note that the order of the steps presented this figure should not be construed as limiting the invention to execution of these steps in that specific order. All that is necessary is that phase 680 of the invention collects the data that is needed for the render phase 690 that follows so that the output work 660 can be generated.

In FIG. 6, a first preferred step might be selection or specification of the desired genre of the output music work 600 by the user. Selectable genres might be provided to the user and might include, for example, House, Techno, EDM, Soundtrack, etc. These examples should not be used to limit the sort of genres that might be available to the user and those of ordinary skill in the art will appreciate that there are many more genres that might be added to this list. Further, it should be noted that the genre list could be an evolving list. That is, genres might be added or removed from the list at any time.

Associated with each genre is the provision of at least one user-selectable template 605 that will be used in the generation of the output music work. The discussion associated with FIG. 4 below contains details of the composition of templates.

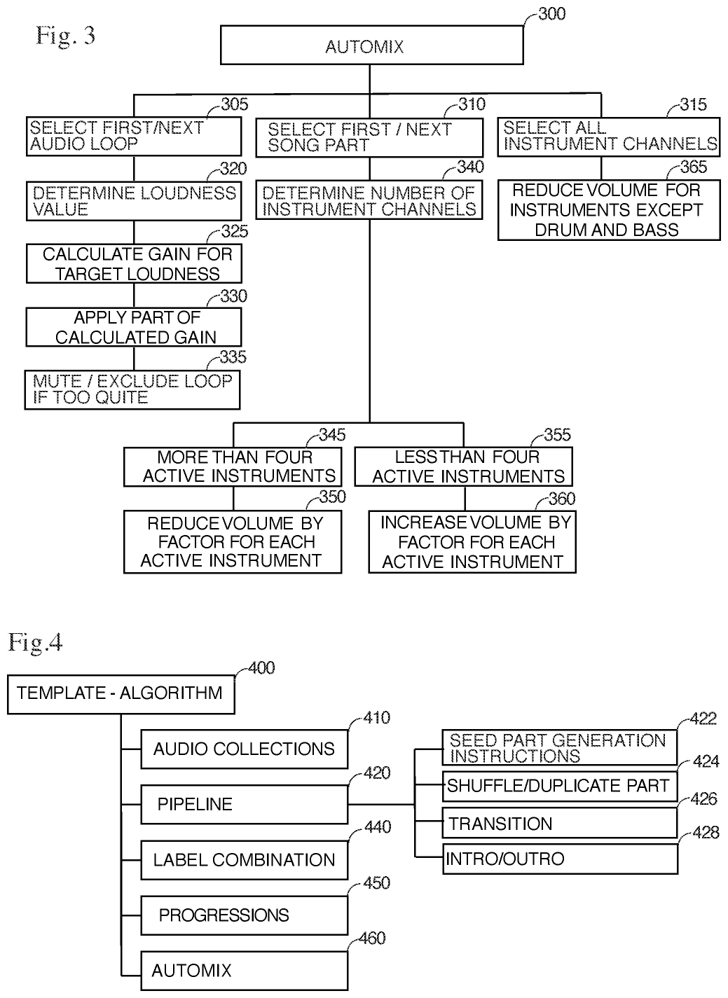

Next, and preferably, the user might be allowed to choose between a collection-based 610 or a mix-pack based 615 music work generation process. The difference between the variants is associated with the type and source of the source audio material that is used in the generation of at least one seed part. One key difference between the two approaches is that in the collection based 610 approach collections of audio material, as disclosed in connection with FIG. 3, are utilized as audio source material. Whereas the mix-pack based approach 615 allows the user to select the individual mixpacks that will be used as audio source material allowing the user to further refine the desired output music work. The text associated with FIG. 4 explains the relationship between mixpacks and collections. FIG. 7 and the discussion associated therewith gives additional details regarding collection-based step 610.

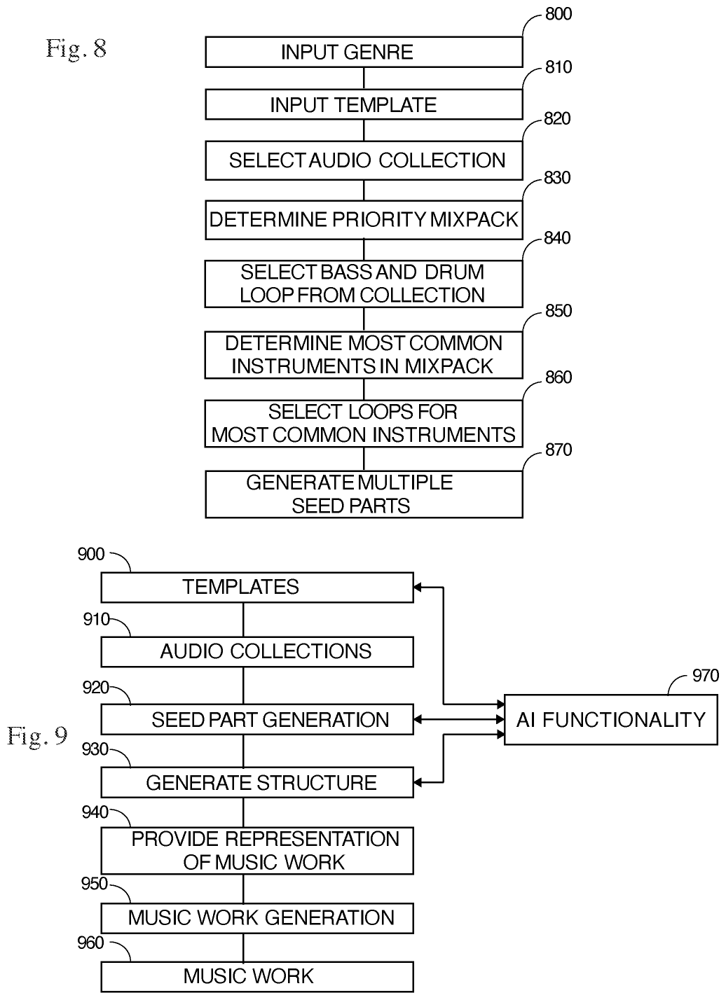

As a next preferred step, the data determination phase 680 is initiated. In the data determination phase 680, data values that define multiple different seed parts are generated 620 and stored using the information provided by the template pipeline seed part generation instructions 422. Additional information regarding the seed part generation is provided in connection with FIGS. 7 and 8.

One component of the determination phase 680 is the generation of the structure 625 of the output music work. As part of this step the instant invention utilizes the data values representing the seed part, variation parts, shuffled parts, intro parts, outro parts and transition parts and applies a structure based at least in part on the order of these parts. As one example, the order of the parts might be flagged as “reverse” so that the previously determined ordering A B C D E F built with information from the seed part returns A B C D E F E D C B. As is indicated in FIG. 6, the first step is the generation of the seed part, then preferably next will be the determination of the structure, followed by the generation of the particular generated parts, wherein the seed part is the initiating data structure for variations and transitions.

The generation of the parts mentioned above takes place in the next three steps. First, the instant invention generates part variations 630 of the previously generated seed part using the information provided by the template pipeline shuffle/duplicate instructions 424. These variation parts might be intro or outro parts or shuffled or duplicate parts. Alternatively, or additionally, this step generates transition parts 635 and, optionally, an intro/outro as has been discussed previously in connection with the information provided by the template pipeline, steps 426 and 428, respectively. As an additional step of the data determination phase 680, the instant invention will determine if vocal parts 640 are to be added to the output music work, where vocal content is obtained from a mixpack containing audio loops with vocal content. The vocal content is specifically prepared for selection and integration into the data values representing the output music work.

As a next preferred step the data determination phase 680 will populate the generated structure 645 of the music work parts with information about audio loops from the collections or mix-packs that have been selected for insertion into the music work parts.

Next, the instant invention will preferably determine values for harmony presets 650. The harmony preset values define the chord progression sequences for each music work part, with these sequences being drawn from a range of provided presets stored in the template. The harmony presets are selected and provided to the render phase 690. As a last step of the data determination phase the instant invention will select and provide the stored data values for the automix algorithm 650 as provided by the selected template algorithm.

Finally, it should be noted that the only essential steps in the data determination phase 680 in FIG. 6 are steps 620, 625, 630, and 645. The other steps may or may not be included at the option of the user or if they are determined to be unnecessary. For example, the automix step might be determined not to be necessary because the loops in the parts were generally in balance. As another example, the user might not be interested in having vocals added to the song.

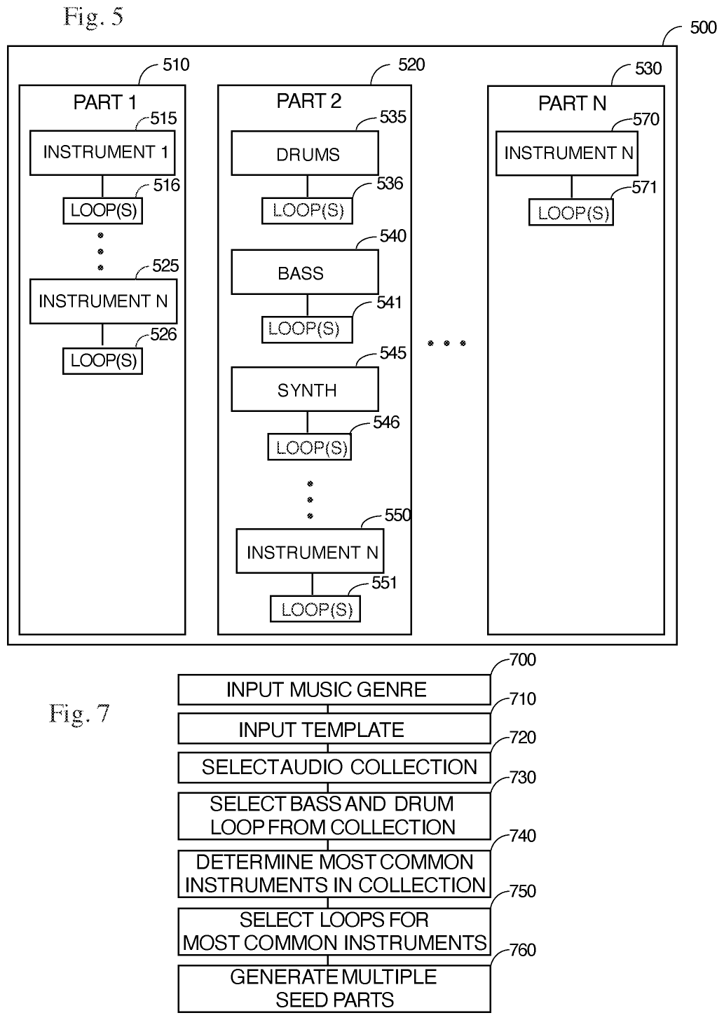

In the render phase 690 the instant invention will utilize the data values from the data determination phase 680. The rendering step will generate the output music work 660 by building the seed part, setting the structure, generating the part variations, transitions, and vocal parts, ordering the structure, populating the structure with audio loops from an audio loop database and then applying the harmony preset settings and the automix values to generate an output work. That is, step 660 utilizes the data values collected in the previous steps. The structure is disclosed in FIG. 5. Seed part generation is explained in connection with FIGS. 7 and 8. Step 660 then results in at least one output work for every generated seed part that preferably contains at least 16 parts, one of which is the seed part. As explained previously, the seed part is most preferably located within the structure of FIG. 5 and is not the intro or outro. Added to the seed part into the structure will be variation parts, transition parts, FX parts, etc.

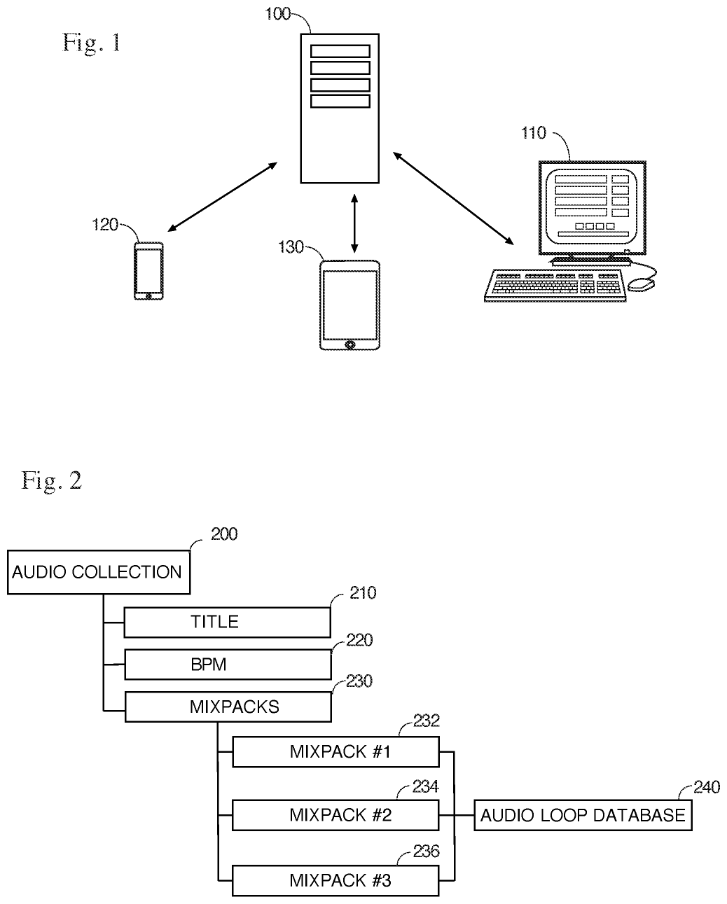

FIG. 2. illustrates a structure and data content of an audio collection 200 suitable for use with the instant invention in step 610 above. As used herein, the term audio collection 200 refers to a data construct that contains references and links to audio material, and audio loops 240, with the audio loops being organized within a so called mixpack unit 230. An audio collection 200 has a title 210 associated with it that allows easy classification of the audio content associated with it. In some embodiments the titles might be suggestive of the general musical theme of its audio content. Examples of titles that might be used include “Low-Fi”, “Hip-Hop”, “Ambient Cinematic”, etc. Each audio collection 200 has an associated bpm 220 (i.e., beats per minute) value that sets out the preferred tempo of the content of the audio collection.

Each audio collection 200 contains one or more different mixpacks 232, 234, and 236, each of which contains or is otherwise associated with some number of audio loops that are musically similar to each other and are compatible with a common genre and also with the theme of the mixpack. Each mixpack might contain audio loops that are stored locally as part of its data structure and/or it might contain pointers to loops that are stored in a general loop database 240 as is indicated in FIG. 2. The loop database 240 might be stored locally or remotely.

Turning next to FIG. 4, this figure illustrates a preferred form of one embodiment of a template 400 that would be suitable for use with the instant invention in step 605 above. A template might be defined as a “one-click” structured algorithm made up of data values that are then utilized by a render engine to generate a complete music work. The individual steps, the algorithms making up the template, also preferably utilize data curated by experts with valuable knowledge in the art of music generation. The template structure of the instant invention contains all of the information that is necessary and needed by the system of the instant invention to build an entire music work.

According to a first aspect of the inventive template, foundational data is accumulated from the audio collection(s) 410 that are available to it. As has been discussed previously in connection with FIG. 2, an audio collection contains one or more mixpacks that the instant invention will draw content from. The selected audio collections and the loops available within their associated mixpacks will preferably have been preselected by experts to steer the sound of the resulting music work according to the desires and the selection of the user.

An additional aspect of the template algorithm is a data construct referred to herein as a pipeline 420. The pipeline 420 contains a list of instructions that are utilized to build the music work and all of its parts. At its most basic level this could be a software module with the instructions embedded in it or read on the fly. In other cases, it could be a collection of high-level instructions or commands, e.g., macro instructions, that are executed by a software engine designed for that purpose. The instructions define, among others, the length and song part structure of the resulting music work.

A main function of the pipeline application is to create song parts from scratch or based on other song parts and, additionally, structuring these parts. More particularly, the pipeline 420 contains instructions and steps that, in essence, generate a plurality of data values, beginning with the generation of a seed part. It should be noted that the sorted listing in this figure is not meant to represent a strict stepwise order of the individual parts in this listing. As has been stated, the template provides a plurality of data values that are then utilized by a render phase to generate the output music work. A seed part is the initial part of the song/music work that embodies the overall concept and feel of the work. One reason for referring to this construct as a “seed part” is that it forms a seed or basis for the steps that follow. For example, the generated shuffled parts, duplicate parts, transition parts, intro and outro parts are built based on the characteristics of the seed part.

Execution of the pipeline instructions generates a seed part that forms part of the initial building block of the music work. The seed part will not typically be the first or last part of the song structure but, instead, it will typically be situated in the body of the work, preceded by at least an intro section and followed by at least an outro section.

The music work parts acting as intro and outro are, at the most basic, variant copies of the parts to which the intro is building and from which the outro is following. According to one embodiment, there is a priority list of instrument channels that are activated (intro) and deactivated (outro) when transitioning from the intro into the body of the music work and from the outro to the music work end. With respect to the intro, preferably these transitions will be achieved by activating instrument channels in a preferred order to transition from the intro to the main body of the music work. Conversely, the outro of the music work will transition to its ending by deactivating instrument channels in a preferred. In one embodiment, the order of activation would be Keys, Strings, Synth, Guitar, Percussion . . . , and the ordering for deactivation would be Drum, Bass, Percussion, Synth, Strings, Keys. Obviously, the particular instruments that are activated/deactivated will depend on the instrument channels that have been created in the music work, e.g., not every music work will have an intro or outro that has a keyboard (i.e., “Keys”) channel.

Another component of the instruction list associated with the pipeline is a collection of steps that indicate how a seed music work part should be generated 422. These steps are utilized in step 620 of FIG. 6, supra. FIG. 7 contains an illustration of one such collection of steps.

FIG. 7 illustrates a workflow that is suitable for use in generating the data values used in building one or more seed parts. The provision of multiple seed parts lead, within the confines of the instant invention, to the output of potentially multiple different, yet somewhat similar, output music works. Additionally, each seed part also allows the instant invention to provide multiple output music works as a result of the instant generative music system.

As is indicated in FIG. 6, the user will already have selected a genre 600 and a template 605. Those of ordinary skill in the art will recognize when the user is required to select a music genre that will mean the user will be required to select a style of music, e.g., classical, jazz, rock, hip-hop, new age, EDM, etc. The instant invention will then provide the user with a list of stored templates 605 for selection that have previously been created by experts. Each template is associated with one or more genres so that when a user selects a genre matching templates can be easily located.

Continuing now with FIG. 7, the input to this process (steps 700 and 710) will be the genre 600 and the template 605 selected by the user. Given that information, the instant invention will then select the audio collection(s) 720 consistent with the information in the selected template. Each audio collection will contain the elements discussed previously in connection with FIG. 2.

Next, a drum audio loop and a bass audio loop will be randomly selected 730. Note that this selection could be from among the audio loops 240 in one of the mixpacks 232, 234 and 236 in the example of FIG. 2. Alternatively, the bass and instrument loops could be selected from the audio database 240 based on the information associated with the seed part.

As a next preferred step, the instant invention will parse through all of the instrument labels (i.e., instrument types) in the audio collection associated with the selected template and determine 740 a list of the instrument labels (i.e., the instrument types) and their frequency in the collection. From this list, an ordering of the frequency of occurrence of each instrument type will be created, and the most common instrument types will be identified. Note that the drum and bass labels/instrument types will be excluded from this list.

Next, the instant invention will identify audio loops associated with the three most commonly occurring instrument types 750. Additionally, in some embodiments a random component can be introduced into the seed part generation process by adding a chance, e.g., a 50% chance, that at least one or more audio loops is added from any of the other less common instrument types. Of course, this percentage can be varied from 0% to 100% to vary the likelihood that a less common instrument will be selected. The instant invention will implement the above steps a number of times to provide the user with multiple seed parts 760 which potentially can lead to multiple output music works.

Returning now to FIG. 4, an additional component of the pipeline instruction list is information and instructions that specify how to obtain shuffled or duplicate music work song parts 424. A shuffled music work song part is derived from a preexisting music work song part. In such an operation, one or more of the audio loops in the preexisting music work will be exchanged with similar audio loops in the music work song part. The algorithmic approach will select a source music work part and will initiate the exchange of similar audio loops. Additionally, there is an option provided that specifies whether the content will not be shuffled, but instead will be copied. In some cases, the option will specify the instrument channels whose content will be shuffled, while all other instrument channels will be copied. The duplicate option will generate an exact copy of an existing music work part from preexisting music work part. This is similar in general concept to the generation of shuffled music work parts. In some variations there are settings stored in the instructions for the instrument channels of the existing music work part, that specify which instrument channels and their content will be defined and will not be copied, or where only defined instrument channels and its content will be copied and nothing else.

An additional component of the pipeline instructions might be the information about the generation of transition parts 426. Transition parts act as bridges between two music work parts. In some variations, the instrument channels might change the audio loops from the earlier music part one channel at a time and music work part by music work part to match the music part that follows. Instructions associate with the transition operation 426 will specify a starting part and an ending part, between the transition music work parts.

A further entry in the instruction list of the pipeline are the instructions for the generation of music work parts that are utilized as intro and outros 428. Instructions for the generation of intro and outro parts are similar in the following respect. In both cases, multi-channel music work parts are generated wherein for intro parts instrument channels are activated one by one and for outro parts instrument channels are deactivated one by one. The instructions will create as many parts as necessary to arrive at the desired target part for both the intro and outro parts. In addition, for the intro a music work part is selected toward which the intro part is building and, for the outro part, a music work part is selected that the outro part is building down from. For both variants the instrument channel deactivation and activation is preferably determined from an ordered list of instrument channels as has been described previously. In some cases there might be instruments that are flagged as never active. Additionally, the lengths (measures, time, etc.) of the intro and outro can be specified separately.

Turning to an additional aspect of the template algorithm structure as set out in FIG. 4, instructions are provided that define preferred or required label or instrument type combinations 440 that will be utilized in the seed music work part generation. The label/instrument combinations consist of lists of instrumental channel combinations that will then be utilized for the creation of a seed music work part. The order of labels defined in the label combinations will determine what instrument channels the determined audio loops will be installed in and what instrument channels the determined audio loops will be selected from. Label combinations might be organized in the template algorithm organization according to this example:

“label_combinations”: [
[“DRUMS”, “BASS”, “SYNTH”, “KEYS”, “PERCUSSION”,
“GUITAR”],...],

Another data value that is utilized and implemented in the music work part generation is called progressions 450 and represents harmony presets, which are chord sequences that might be chosen for each music work part in a data collection representing an output music work. The chord sequences utilized for individual music work parts are drawn at random from a range of hard coded, predetermined and provided presets. These presets might be organized in the template algorithm organization according to this example:

“progressions”: [
“aaaaaaaaCCCCCCCC”,
“CCCCCCCCG#G#G#G#G#G#G#G#”,
],

In the example above, each letter represents one beat (not one bar) and major chords are represented with upper case letters, while minor chords are written in lower case. In some cases, these presets might correspond to standard music chord change patterns. e.g., 1-5-6-4 (e.g., C, G, Am, F), 6-4-1-5 (e.g., Am, F, C, G), 1-4-5-4 (e.g., C, F, G, F), 1-6-4-5 (e.g., C, Am, F, G), 2-5-1-6 (e.g., Dm, G, C, Am), etc.

Another set of instructions that might be included as part of the instruction list contained in the pipeline 420 are directions associated with the automix algorithm 460 that aims to provide a more balanced mix of the music work parts.

FIG. 3 contains a workflow representative of an automix algorithm of the sort called for in steps 460 and 655 suitable for use by the instant invention. The different approaches are applied to the music work preferably within the music work generation step (step 655). In other cases, the automix algorithm might be applied to the music work after it is generated, i.e., to the final product after the music generation step 690. The automix workflow of FIG. 3 is one component of the algorithmic approach embodied in the template 400 structure discussed previously.

The automix volume adjustment 300 multi-step process of FIG. 3 is designed to adjust the volumes of the audio loops and instrument channels automatically based on perceived loudness of the music content. One reason that this might be done is because loops that might be used in this embodiment may have greatly varying loudness, from too soft to too loud and potentially every volume level in between. Note that the automix process 300 is provided as part of the instructions 460 within the template 400.

To address this problem the instant invention utilizes the automix algorithm of FIG. 3 as part of the music generation process. The automix algorithm utilizes the stored measurement value of the integrated loudness of each audio loop in a database of loops from which the mixpacks are drawn and assembled. This value will preferably have been measured using the algorithm specified in ITU-R 1770-3 (the disclosure of which is fully incorporated herein by reference) and saved as part of the metadata associated with each loop. The ITU-R 1770-3 algorithm is one that is commonly used in the audio industry to measure the perceived loudness of audio program material. It is essentially a windowed RMS level integrated over the entire length of the audio material, but also includes frequency weighting to account for the sensitivity of human ears to different frequency ranges. The algorithm also employs gating to make sure that silent or quiet sections between loud sections will not bring down the average loudness measurement.

The volume levels of the generated music work are adjusted by applying the automix algorithm to the music work's audio loops and/or its song parts and/or or its instrument channels. These adjustments are applied in multiple steps and preferably at different granularity levels. Each step might be applied alone or all of the approaches in FIG. 3 might be applied sequentially to the music work.

The first granularity level involves a loudness adjustment being made to all audio loops that are part of the music work. As is illustrated in FIG. 3, as a first preferred step the first or next each audio loop 305 will be selected and a loudness value determined 320. As a next preferred step, the gain necessary to amplify (or quiet) the selected loop to a target loudness level specified by the user is calculated 325. In a next preferred step, the instant invention will only apply a portion 330 of the calculated gain to the loop, for example 60% of the calculated gain might be applied. This might be for many reasons but one rationale is that it is desirable to keep the dynamics of the audio loops, and the music work formed from those loops, within the bounds intended by the individual(s) who populated the loop database with audio loops. In some embodiments, the loops will be selected and/or produced by music experts, e.g., music producers, and added to a loop database that is intended to be used by the instant invention. Generally, the loops are produced in ways that will be compatible with one or more of the genres that might be selectable by the user but, of course, how those loops would be combined with others and the target volume of the generated music work would be unknown at the time the loops were added to the database. Additionally, this loop focused process automatically excludes very quiet audio loops 335, which might be those loops that are at a low volume level and have no appreciable dynamic range, e.g., if the only sound is tape hiss or some similar content. Note that steps 305-335 are performed for each loop in the music work.

A second/higher level of granularity is an adjustment of the volume of each song part 310 that makes up the music work, with the goal being to make the different song parts more consistent in volume. As a first preferred step for each song part the instant invention will determine the number of active instrument channels 340. If the number of active instrument channels is above four 345, the volume of all instrument channels will be reduced by a factor 350, for example 0.5 dB. If the number of active instrument channels is less than four then the instant invention 355 will, for each song part, increase the volume of all instrument channels by a factor 360, for example 0.5 dB. The 0.5 dB value was selected based on the experience of the inventors with a goal of keeping the loops in the song part in balance. Note that the 0.5 dB value was empirically determined and could be, for example, 0.25 dB, 0.5 dB, 0.75 dB, 1.0 dB, etc., depending on the loops involved and the tastes of the user. Those of ordinary skill in the art will readily understand how this value might be chosen in a particular case.

The third and highest granularity level is a volume adjustment based on instrument channels. In a first preferred step, all instrument channels are selected 315 and the volume of these instrument channels reduced by a predetermined or calculated value 365, for example a reduction by 2 dB is one suitable value. In this third granularity level, the volumes of the drum and bass instrument channels will not be reduced by this amount. This approach is designed to shift the audio experience in favor of instrument channels that typically make up the power/energy of the music work, i.e., the drum and bass content. Although 2 dB is a preferred value, other choices based on the experience of the instant inventors might be, for example, I dB, 4 dB, and 5 dB.

As one possible alternative to the process discussed above, manual pre-set volume level offsets might be provided for specified instrument channels. Adjustment values given in decibels might be provided. In many cases, mostly negative values will be utilized. These presets might be organized in the template algorithm organization according to this example:

```
″levels″: {
  ”DRUMS“ −3,
  ”BASS“ −6”,
  ″FX″: −5,
  }
```

Turning next to FIG. 5, this figure illustrates an example song skeletal structure 500 of a music work according to an embodiment. This structure functions as the starting point for the functionality of the instant invention. It is initially generated empty and filled with loops as the output music work is generated. Information representing a music work generated by an embodiment will consist of a number of individual song parts, Part 1 510, Part 2 520, and Part N 530, where the “N” in Part N 530 merely indicates that a music work might consist of an arbitrary number of song parts, one of which being a seed part. As discussed previously, a seed part is a song part that contains the whole concept of information for a music work.

Each song part has a specific runtime at a given tempo. The run time might be defined in terms of measures instead of time, for example, 4 or 8 measures or multiples thereof. Additionally, the song parts might be further identified by, for example, designating them as being an intro, ending, verse, chorus, bridge, etc. FIG. 5 also generally indicates that each song part of a music work preferably consists of an arbitrary number of instrument channels, each of which includes at least one instrument audio loop. Note that an audio loop is a digital section of sound material that typically, although this is not a requirement, may be seamlessly repeated, i.e., “looped”. Further, even though this specification may refer to channels as instruments that was only for convenience because an “instrument” might include more than one instrument. A loop could, as one example, contain an audio recording of an entire orchestra although that is not a preferred type of loop. Also, note that the parameter “N” as used throughout the figures and specification should be broadly construed generically to be any integer number of parts, samples, etc., and the fact that “N” is used two or more times in the same figure does imply that it must take the same numerical value throughout that figure. That is, “N” as it is used in Instrument N 525 need not have the same numerical value as the number of song parts Part N 530.

In FIG. 5 the instrument channels associated with Part 2 520 are drums 535, bass 540 and synth 545, etc., each of which is associated with loop(s) of that instrument type, i.e., 536, 541, and 546, respectively. These instruments are given as examples only and are not intended to limit the scope of the instant invention to only these instrument variations. On the contrary it should be clear that any number of other instrument channel choices are certainly possible, and the limitation to the three instrument channels illustrated in this figure is only for illustrative purposes. For each of the available and potentially selected instruments at least one audio loop 555 at a time is selectable 560 and will be played during the play back of the particular music work part. The selection for integration of each audio loop is carried out automatically by the instant invention during a rendering phase.

Coming next to FIG. 8, this figure illustrates a preferred workflow variant for generating data values for building multiple seed parts using the selected genre 600 and template 605 selections by the user. The provision of multiple seed parts leads within the confines of the instant invention to the output of potentially multiple different, yet somewhat similar, output music works. Additionally, by using the mixpack content each generated seed part also allows the instant invention to provide multiple output music works as a result of the properties of the instant generative music system.

An embodiment that illustrates a preferred approach to generating the seed part is contained in FIG. 8. The input (i.e., boxes 800 and 810) to this process will be the previously selected music genre 600 and template 605. In a next preferred step, given the user's genre picks the instant invention will then select the audio collection 820 identified in the selected template. As noted previously, the audio collection contains mixpack associations. Preferably the user will be able to further define a priority mixpack from the mixpack associations 830. The instant invention will then preferably randomly select 840 an audio loop from a drum instrument channel and an audio loop from a bass instrument channel from the selected audio collection.

Next, the instant invention will utilize the priority mix-pack selection and parse through all instrument channel labels in the specified mixpack and determine 850 a list and order of the most common instrument channel labels for that mix-pack. As mentioned previously, this list will exclude bass and drum instrument channels from the ordered list. The instant invention will then select audio loops which are associated with at least the top three of an ordered list of the determined most common instrument channel labels/types 860. Additionally, the instant invention will optionally randomly select at least one other audio loop from any of the less common instrument channel labels. The instant invention will typically implement the above disclosed steps a plurality of times to provide the user with multiple seed parts 870 which, in turn, can lead to multiple output music works.

FIG. 9 contains an illustration of some of the individual parts of the instant invention and their connection to AI functionality. Beginning with the generation of templates, templates 900 provide, as has been described above, the frameworks for intelligent rule-based algorithms to control output music work creation, wherein these templates utilize AI functionality 970. The AI will have been previously trained using templates that have been created by experts for a variety of different genres.

The audio collections 910 are repositories of audio material based on a thematic approach, preferably genre. The next part is the seed part generation 920, which represents an AI model 970 that utilizes a set of audio loops as the basis for the output music work concept. A variety of methods are utilized to generate the seed parts, there might be GAN generated seed parts, AI template generated seed parts 970, or AI machine learning based generated seed parts.

The AI in this step will previously have been trained on a number of loops, preferably the loops in the database 240. In one embodiment, the content of the loop database will be analyzed by an algorithm which provides data values for around 200 fundamental/low level parameters of each audio loop including. These parameters might include, for example, volume, loudness, FFT (e.g., the frequency content of the loop or sound based on its fast Fourier transform and/or its frequency spectrum) etc. In one preferred embodiment the analysis might continue by using PCA (principal component analysis), linear discriminant analysis (“LDA”), etc. LDA will be performed on the fundamental/low parameters to reduce their number and dimensionality. Methods of reducing dimensionality using PCA and LDA in a way to maximize the amount of information captured are well known to those of ordinary skill in the art. The resulting summary parameters which, in some embodiments might comprise at least eight or so parameters, will be used going forward. The summary parameters might include one that corresponds to the instrument(s) that are predominant in each loop.

The next part is the generation of a structure 930 of the audio loop sequence. In this case, an unsupervised process AI model 970 utilizes the seed part and intelligently selects and assembles a set of audio loops into a sophisticated music work structure. This process applies the AI template to the contextual numerical relationship between the audio loop sounds, as derived by a convolutional neural network audio signal retrieval process that the audio loops have been subjected to prior to storage in the database, wherein a particular numerical value uniquely represents each audio loop. As before, the AI will previously have been trained on music works of different genres, tempos, lengths, etc.

As a next preferred part there is the provision of a representation of an output music work 940, wherein the system provides a symbolic representation of the output music work as a machine readable alpha numerical file or metadata file. The next part is the music work generation 950 wherein the render engine reads the symbolic presentation of the output music work and generates an output music work as the final part 960. The AI 970 is one that has been trained on different genres of music and is able to assist the instant invention in forming and selecting templates, generating seed parts, and establishing the structure of the music work. As has been noted previously, the fact that the steps of FIG. 9 are presented in the form of a flow chart should not be used to infer that these steps all take place or that they take place in the order shown in that figure.

It should be noted and understood that the invention is described herein with a certain degree of particularity. However, the invention is not limited to the embodiment(s) set for herein for purposes of exemplifications, but is limited only by the scope of the attached claims.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

The singular shall include the plural and vice versa unless the context in which the term appears indicates otherwise.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least” means or more than. The term “at most” followed by a number is used herein to denote the end of a range ending with that number (which may be a range having or 0 as its lower limit, or a range having no lower limit, depending upon the variable being defined). For example, “at most 4” means 4 or less than 4, and “at most 40%” means 40% or less than 40%.

Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±0% of the base value.

When, in this document, a range is given as “(a first number) to (a second number)” or “(a first number)-(a second number)”, this means a range whose lower limit is the first number and whose upper limit is the second number. For example, 25 to 00 should be interpreted to mean a range whose lower limit is 25 and whose upper limit is 00. Additionally, it should be noted that where a range is given, every possible subrange or interval within that range is also specifically intended unless the context indicates to the contrary. For example, if the specification indicates a range of 25 to 00 such range is also intended to include subranges such as 26-00, 27-00, etc., 25-99, 25-98, etc., as well as any other possible combination of lower and upper values within the stated range, e.g., 33-47, 60-97, 4-45, 28-96, etc. Note that integer range values have been used in this paragraph for purposes of illustration only and decimal and fractional values (e.g., 46.7-9 0.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 0% of the base value.

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A method of automatically generating a musical work in a computer, comprising the steps of:
(a) receiving from a user a selection of a genre;
(b) receiving from the user a selection of either a collection-based template or a mix-pack-based template;
(c) generating at least one seed part;
(d) generating a song structure;
(e) using at least one of said at least one seed parts to generate part variations;
(f) generating at least one transition part;
(g) generating at least one vocal part;
(h) adding at least said at least one generated seed part, said at least one part variations, said at least one transition part, and said at least one vocal part to said generated song structure;
(i) determining at least one harmony preset;
(j) determining at least one automix value;
(k) using at least said song structure, said at least one harmony presets, and said at least one automix value to generate said musical work; and
(l) performing at least a portion of said musical work for the user.

2. The method according to claim 1, wherein said musical work comprises at least an into song part, a first body song part following said intro song part, and an outro song.

3. The method according to claim 2, wherein said intro song part comprises a first plurality of channels and said outro song part comprises a second plurality of channels.

4. The method according to claim 3, wherein said intro song part transitions into said first body song part by
(i) activating only a single channel,
(ii) at a later time activating a second channel so that only two channels are activated, and
(iii) continuing to activate additional channels at predetermined time separations between activations until all of said first plurality of channels are activated.

5. The method according to claim 3, wherein said outro song part transitions into a musical work ending by
(i) deactivating a first channel of said second plurality of channels,
(ii) at a later time deactivating a second channel so that only two channels are deactivated, and
(iii) continuing to deactivate additional channels at a predetermined time separation until all of said second plurality of channels are deactivated.

6. The method according to claim 4, wherein each of said first plurality of channels has an instrument associated therewith and wherein said first plurality of channels are activated in an order comprising a keys instrument channel, a strings instrument channel, a synth instrument channel, a guitar instrument channel, and a percussion instrument channel last.

7. The method according to claim 5, wherein each of said second plurality of channels has an instrument associated therewith and wherein said second plurality of channels are deactivated in an order comprising a drum instrument channel, a bass instrument channel, a percussion instrument channel, a synth instrument channel, a strings instrument channel, and a keys instrument channel.

8. A method of automatically generating a musical work in a computer, comprising the steps of:
(a) receiving from a user a selection of a genre;
(b) receiving from the user a selection of either a collection-based template or a mix-pack-based template;
(c) generating at least one seed part;
(d) generating a song structure;
(e) using at least one of said at least one seed parts to generate part variations;
(f) adding at least said at least one generated seed part, and said at least one part variation to said generated song structure;
(g) using at least said song structure to generate said musical work; and
(h) performing at least a portion of said musical work for the user.
